(19) United States
(12) Patent Application Publication
(10) Pub. No.: US 2007/0083431 A1
(43) Pub. Date: Apr. 12, 2007

(54) Method of promoting a concentrated product line

(75) Inventor: Douglas L. Glasscock, Blue Springs, MO (US)

Correspondence Address: LAW OFFICE OF JOHN C. MCMAHON, P.O. BOX 30069, KANSAS CITY, MO, 64112, US

(73) Assignee: Liquid Soap Products, Grain Valley, MO (US)

(21) Appl. No.: 11/512,023

(22) Filed: Aug. 29, 2006

Related U.S. Application Data
(60) Provisional application No. 60/724,949, filed on Oct. 7, 2005.

(51) Int. Cl. G06Q 30/00

(52) U.S. Cl. 705/14

(57) ABSTRACT

A method of advertising a comprehensive line of concentrated products of a single advertiser comprising the steps of placing the advertiser's products on a planar layout and locating an equivalent amount of competitor's non-concentrated products in sectors radiating out from and adjacent to the concentrated products so as to provide a consumer with a visual comparison between the products and so as to persuade the consumer to purchase the concentrated products.

### CROSS-REFERENCE TO RELATED APPLICATIONS

This application claims the benefit of U.S. Provisional Application No. 60/724,949 filed Oct. 7, 2005.

### BACKGROUND OF THE INVENTION

The present invention is directed to a method of promoting a line of concentrated products, especially cleaning and related fields for use in home or industry.

The inventors of the present application found that various concentrates of cleaning and related products have existed in the prior art and were utilized by consumers to produce final products in a diluted form which were either used to refill previously purchased containers or simply used for various household or commercial purposes. However, in most cases the manufacturer or seller produced only a single product or may have produced multiple products, but advertized such individually. The inventors hereof recognized a need for a comprehensive line of concentrated products that could be advertised and promoted by a single promotional method.

### SUMMARY OF THE INVENTION

A method is provided to promote multiple concentrated products in a comprehensive single advertisement. The advertisement comprises a layout format wherein each of the products of the advertiser are located about a margin of a single sheet or a circle or other geometric shape on the sheet and compared to a competitor's non-concentrated product by showing the number of containers of the competitor's product that provides the equivalent amount of the advertiser's non-concentrated product after proper dilution of the advertiser's products. In some situations, each product of the advertiser is compared to only a single competitor product. However, it is foreseen that one or more products of the advertiser could be visually compared to the equivalent end product amount of the products multiple competitors.

### OBJECTS OF THE INVENTION

Therefore, the objects of the present invention are: to provide an advertising format, system or method wherein an advertiser who sells a line of concentrated products for cleaning and the like can advertise in a single comprehensive format; to provide the method including the step of comparing each of the advertiser's products to physical representatives of competitor's non-concentrated products wherein the competitors sell diluted or ready to use products; to provide such a method having a layout wherein the advertiser's products are shown along a margin or about a central geometric shape such as a circle and the competitor's products are shown in wedge or pie shaped regions or sectors next adjacent to the advertiser's products and fanning out therefrom to the opposite side of the layout or outer margins of the layout; and to provide such a method which is especially suited for advertising the products of the advertiser and especially adapted for the intended use thereof.

Other objects and advantages of this invention will become apparent from the following description taken in conjunction with the accompanying drawings wherein are set forth, by way of illustration and example, certain embodiments of this invention.

The drawing constitutes a part of this specification and includes exemplary embodiments of the present invention and illustrates various objects and features thereof.

### BRIEF DESCRIPTION OF THE DRAWING

FIG. 1 is a schematic representation of an advertising layout showing the advertiser's concentrated products on the left side of the layout and the equivalent number of non-concentrated products of competitors that provide the same quantity of final product as the advertiser's products fanning out to the right from the advertiser's products.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details, as well as method steps, disclosed herein are not to be interpreted as limiting, but merely as a basis for the claims and as a representative basis for teaching one skilled in the art to variously employ the present invention in virtually any appropriately detailed structure or method.

In accordance with the invention, a method is provided for advertising or promoting the products of a company wherein the advertiser's products are concentrates of plurality of various products that are diluted for use by a consumer, including cleaning products.

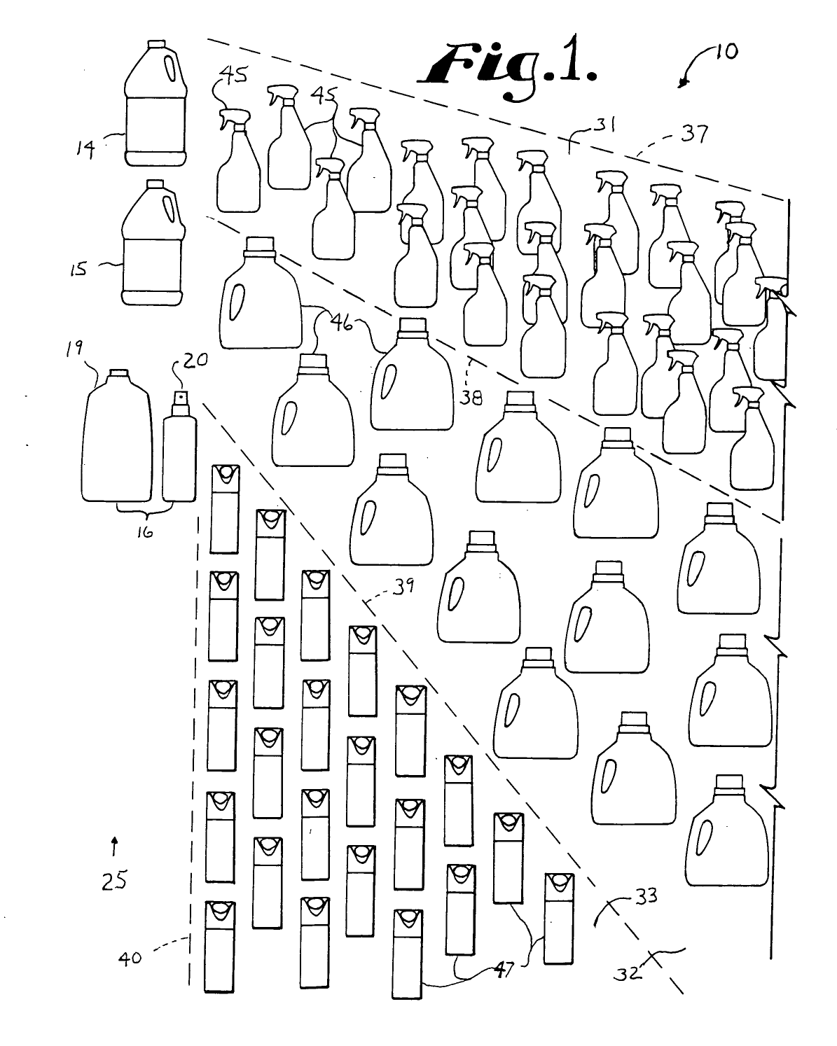

Shown in FIG. 1 is a fragmentary, single and planar advertising page layout 10 illustrating various concentrated products 14, 15 and 16 manufactured by the advertiser. Each of the products 14, 15 and 16 are consistent in scale with one another. Product 14 is a pine scented disinfectant. Product 15 is a liquid laundry detergent. Product 16 is a combined concentrate container 19 of spray cleaner and a pump sprayer 20 for dispensing diluted concentrate in the container 19 after dilution by the consumer. The advertiser's products 14, 15 and 16 are all located in a vertical column (designated by the arrow 25) or adjacent one another near the left hand margin of the layout 10.

To the right of the products 14, 15 and 16 are wedge or pie shaped sectors 30, 31 and 32 generally separated or grouped by imaginary dividers 37, 38, 39 and 40 which generally define the sectors 30, 31 and 32 from a presentational point of view.

Located in the first sector 31 is a plurality of containers 45 of a competitor's product in non-concentrated or diluted and final use form that competes with advertiser's product 14. The number of containers 45 are equal to the number needed to match the amount or quantity of the product 14 after dilution and are on the same scale with the product 14.

Likewise, located in sector 32 are the number and quantity of competitor's products 46 that compare to diluted amounts of advertiser's product 15. Further, sector 33 shows a visual image of the number and quantity of competitor's products 47 that compare to diluted amounts of advertiser's product 16.

Thereby, the present method allows an advertiser to visually display and illustrate to buyers or consumers the difference in size, volume and quantity of advertiser's products 14, 15 and 16 versus equivalent non-concentrated products 45, 46 and 47 of competitors. It also allows a consumer to visually understand how much of the advertiser's products 14, 15 and 16 are obtained from purchase of a single container 14, 15 or 16 compared to those of others.

This method can be used to illustrate more than the illustrated three products 14, 15 and 16 and instills in consumers the concept that buying a comprehensive line of products from the advertiser has many benefits such as lower cost, fewer trips to the store, less storage requirement and less trash.

It is to be understood that while certain forms of the present invention have been illustrated and described herein, it is not to be limited to the specific forms or arrangement of parts described and shown.

What is claimed and desired to be secured by Letters Patent is as follows:

1. A method of promoting a comprehensive line of concentrated products in comparison to non-concentrated products comprising the steps of:
a) providing a layout sheet;
b) placing a plurality of individual containers of concentrated products along one portion of said sheet;
c) in sectors radiating away from the containers of concentrated products placing containers of non-concentrated products; and
d) wherein the concentrated containers and non-concentrated containers are displayed in portion to the equivalent amount of final product provided by each.

2. The method of claim 1 wherein:
a) said concentrated products are a product line of a single advertiser and the non-concentrated products are those of competitors of the advertiser.
